(19) United States
(12) Patent Application Publication
(10) Pub. No.: US 2012/0232804 A1
(43) Pub. Date: Sep. 13, 2012

(54) SYSTEM AND METHOD FOR PARAMETER ESTIMATION IN BIOLOGICAL PROCESSES

(75) Inventors: Anthony Bryan Pleasants, Hamilton (NZ); Cameron Angus McLean, Auckland (NZ); Graeme Charles Wake, Auckland (NZ); Allan Michael Sheppard, Cambridge (NZ); Peter David Gluckman, Auckland (NZ)

(73) Assignee: AUCKLAND UNISERVICES LIMITED, a New Zealand Co., Auckland (NZ)

(21) Appl. No.: 13/509,947

(22) PCT Filed: Nov. 15, 2010
(86) PCT No.: PCT/NZ2010/000226

§ 371 Date: May 15, 2012

(30) Foreign Application Priority Data
Nov. 18, 2009 (NZ) 581271

(51) Int. Cl. G06F 19/00

(52) U.S. Cl. 702/19

(57) ABSTRACT

A method of measuring a biological process, the method including the steps of: (a) determining a probability density function for a series of repeated measurements of the biological process; (b) approximating the probability density function utilising a parametric formula; (c) determining a maximum likelihood estimator for the parametric formulation of the probability density function; and (d) utilising the maximum likelihood estimator for subsequent measurements of the biological process.

### FIELD OF THE INVENTION

The present invention relates to the parameter estimation of biological processes and, in particular, discloses a method of more accurately measuring a biological process such as CpG methylation or the like.

### BACKGROUND OF THE INVENTION

In the accurate measurement of biological processes, approximations and inexact recording of measured values give rise to errors. Various techniques have evolved to minimise or reduce the influence of errors in measurement. One popular technique is the “least squared” approach is commonly used to reconcile measured data to a predetermined model. The least squared approach relies upon the pivotal assumption of a normal or Gaussian frequency distribution if correct inferences are to be made. Where the underlying distribution is not normal, parameter estimates may be inefficient and the resulting inferences misleading. The utilisation of a least squared approach in such circumstances is therefore likely to lead to incorrect results.

For example, measurements of biological processes occurring at the molecular level are subject to nonlinear effects, such as thresholds or multiple equilibria, and as such result in frequency distributions which are often far from normal. In these circumstances classical least squares analysis may not be appropriate and alternative methods relying on an “analysis of the likelihood” are needed. However, likelihood based methods require a detailed knowledge of the probability density governing the process of interest.

The dynamic regulation of gene expression represents a molecular level biological process which occurs through multiple mechanisms. One particular biological process of interest for which it is desired to obtain accurate measurements forming the basis of diagnostic prediction is the measurement of the degree of CpG methylation of biological substances. Normally, the measurements are carried out utilising an appropriate machine. For example, the well known Sequenom machine is adapted to measure a degree of methylation of biological material.

Within the sample of cells measured by an instrument like a Sequenom machine, cell types may be mixed. If the CpG site represented in one cell type is methylated but not in other cell types this would result in the machine reading a proportional measurement for the degree of methylation at this site. Alternatively, within cells of the same type methylation at a given CpG site may not be universal, and thus represent a further issue in respect to the expression of any related traits.

The utilisation of methylation measurements in the determination of genetic traits is becoming increasingly popular. For example, US Patent Publication No. 2009/0104615 entitled “Phenotype Prediction” discloses utilisation of methylation for the determination of propensity for expressed biological traits. The contents of the aforementioned application are incorporated by cross-reference.

The methylation measurements are unlikely to have a normal or Gaussian distribution of error. It is therefore important to provide for an alternative form of approximation or parameterization of measurements.

### SUMMARY OF THE INVENTION

It is an object of the present invention to provide an alternative form of measurement of biological processes.

In accordance with a first aspect of the present invention, there is provided a method of measuring a biological process, the method including the steps of: (a) determining a probability density function for a series of repeated measurements of the biological process; (b) approximating the probability density function utilising a parametric formula; (c) determining a maximum likelihood estimator for the parametric formulation of the probability density function; and (d) utilising the maximum likelihood estimator for subsequent measurements of the biological process.

In one embodiment, the biological process comprises CpG methylation measurements. Preferably, the method includes fitting a parametric exponential decay formula to the probability density function and further fitting a parametric Hermite polynomial to the residual after fitting the parametric exponential decay formula.

Preferably, the probability density function is of the form:

f(z)=Q⁻¹pe^{-p|z|}[1+qH₃(|z|)]

where |x| is the absolute value of the CpG methylation, p and q are parameters, H₃(z) is the 3^{rd} order Hermite polynomial of the form z³−3z, and Q is a normalisation constant. The parameters p and q can be obtained utilising a maximum likelihood process.

### BRIEF DESCRIPTION OF THE DRAWINGS

Preferred forms of the present invention will now be described with reference to the accompanying drawings in which:

FIG. 1 illustrates a histogram of the deviations of 1440 repeated measurements between two methylation measures of the same CpG from the same sample. Though not obvious about 3% of values are greater than the absolute value of 0.2;

FIG. 2 illustrates a histogram of the proportion of methylation of CpG 2;

FIG. 3 illustrates box plots of the proportion of methylation for SGA and AGA individuals for CpG 4 of gene H19; and

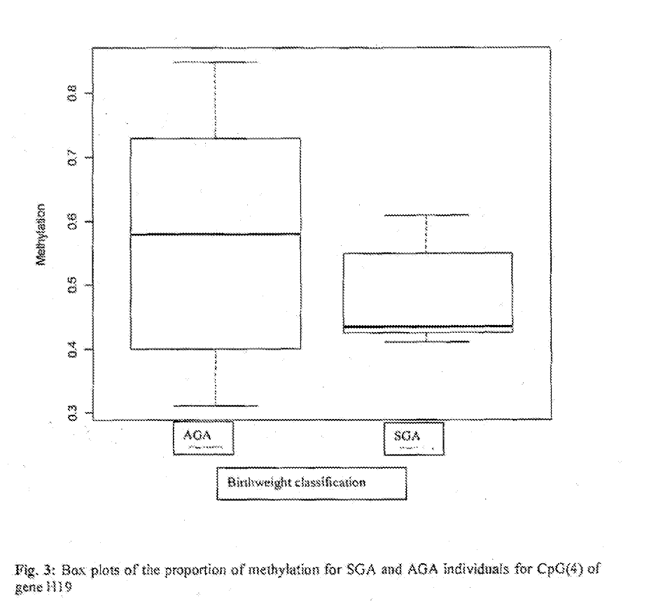

FIG. 4 illustrates a series of steps provide in the preferred embodiment.

### DESCRIPTION OF PREFERRED AND OTHER EMBODIMENTS

In the preferred embodiment, an extensive analysis is undertaken of the potential error measurements in methylation measurements. From the extensive analysis, a number of factors were derived and an alternative, more effective probability density function defined. The initial probability density function of the preferred embodiment was derived after conducting large scale measurements of frequency distributions of CpG methylation measurements.

On examination, frequency distributions of CpG methylation measurements were found to include two important characteristics that a suitable probability density needs to describe: The frequency distribution has a high degree of skew, with a high frequency of extreme values. The frequency distribution is bounded between the values of [0 1], representing the case where measurements cannot be less than zero or greater than 100% methylation in the population of cells measured.

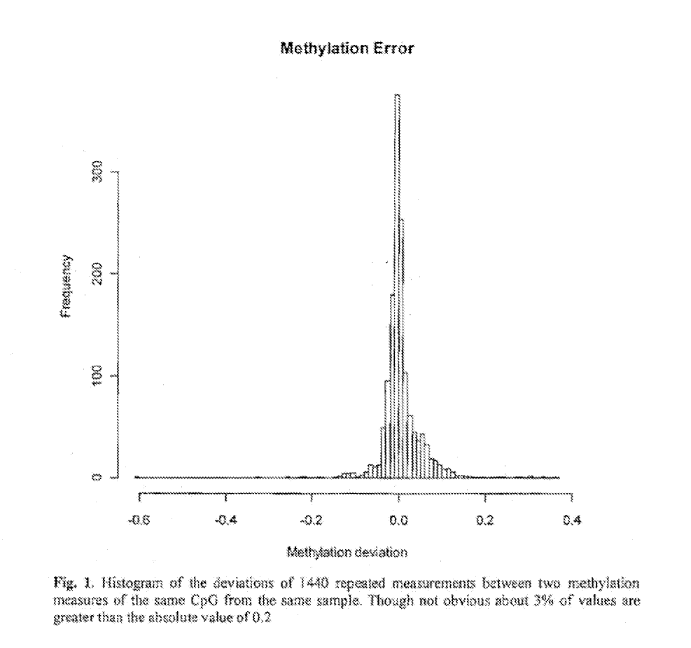

Both these characteristics mean that the probability density describing the CpG methylation measured by say a Sequenom machine is far from a normal frequency distribution. An example derived from empirical measurements is shown in FIG. 1. FIG. 1 illustrates a histogram of the deviations of 1440 repeated measurements between two methylation measures of the same CpG from the same sample. About 3% of the values are greater than the absolute value of 0.2. The distribution, as illustrated, can be seen to be non-Gaussian. In these circumstances estimation and inference based on methylation measurements which apply least squares procedures may be inefficient and potentially misleading.

The preferred embodiments provide a probability density for the proportion of methylation measured at a given CpG site in the promoter of a given gene based on a large number of repeated measurement of the same sample made on the Sequenom machine. Maximum likelihood estimators based on this probability density are determined and applied to relate the proportion of CpG methylation to various phenotypic measures. The method of a preferred embodiment provides for improved reliability of estimates.

In order to derive an appropriate probability density function, two Sequenom measurements of 1440 samples of human cord tissue were made and the difference between the measurements recorded. This difference represented the deviation in the measurement of CpG methylation due to environmental factors.

In the preferred embodiment, there is provided a new form of suitable probability density description that is suitable for describing the measured deviations in the CpG methylation measurements. The probability density function approximation involves expanding a series of Hermite polynomials about a ‘key’ or basis parametric probability density. The basis probability density function is an exponential probability density. In effect, the Hermite polynomial series addition to the ‘key’ probability density adjusts the higher moments, particularly the skew (via a 3^{rd} order Hermite polynomial) and the kurtosis (via a 4^{th} order Hermite polynomial).

From an inspection of the histogram in FIG. 1, it was determined that a Laplace probability density was chosen as the key function. This distribution, also called the double exponential distribution, is in effect back to back exponential probability densities centred on zero. The distribution is suitable for describing random variables which can take positive or negative values, each domain having an exponential probability density. The Laplace probability density is a consequence of the difference between 2 random variables when each random variable is from an exponential distribution.

The exponential probability density has the property of ‘memorylessness’. It also describes a random process where there is a constant probability for the time between extreme events. That is, an exponential probability density describes the situation where cells with CpG methylation characteristics which deviate notably are found with a constant probability. This would be the case if a sample contained cells operating differently from the bulk of cells in the sample, whether because they were of a different type or for some other reason.

However the direct fit of an exponential distribution to the methylation data was found to be poor, in particular failing to properly describe the tails of this frequency distribution. To deal with this problem the Laplace probability density is adjusted by the addition of Hermite polynomials using the algorithm similar to that described in Buckland, S. T, “Maximum Likelihood fitting of Hermite and simple polynomial densities”, Applied Statistics 41: (1) 241-266, (Buckland (1992b)). This calculation showed that the addition of a 3^{rd} order Hermite polynomial more accurately described the CpG methylation frequency distribution shown in FIG. 1. Thus, the probability density describing the CpG methylation data can be described as:

f(z)=Q⁻¹pe^{-p|z|}[1+qH₃(|z|)] (Eqn 1)

where |x| is the absolute value of the CpG methylation, p and q are parameters, H₃(z) is the 3^{rd} order Hermite polynomial equal to z³−3z, and Q is a normalisation constant. The support for the probability density of equation 1 is on the interval [−1 1]. Q is given by:

$$Q = {\int }_{- 1}^{1} p {e}^{- p \vert z \vert} [ 1 + {qH}_{3} ( \vert z \vert ) ] d z , so$$

$${Q}^{- 1} = \frac{{p}^{2}}{2 \{ {p}^{2} + 3 qp + 6 q - {e}^{- p} ( ( 1 - 2 q ) {p}^{2} + 6 pq + 6 q )}$$

The form of the probability density of Equation 1 shows that the mid range and tail of the methylation probability density is reduced compared with that for the Laplace density. This means that the rate at which extreme deviations in the repeat measurements occur is at a lower rate, and falls at a faster rate, than would occur if the probability law of the exponential density was operating. That is, the frequency of extreme methylation measurements is less than what would occur if the extreme events occurred at a constant frequency.

For the CpG methylation data set described, the maximum likelihood estimates were calculated by the method similar to that described by Buckland (1992b) for the parameters in equations (1) are p=5.254±0.01674; q=0.025±0.0046, with a correlation between these variables of 0.82. This means that the skew component represented by the 3^{rd} degree Hermite polynomial acts more strongly on larger deviations. For example, at a deviation of 0.1 this component adds −0.299 units to the estimate of the frequency, while at a deviation of 0.9 it adds −1.971 units. This results in the tail of the frequency distribution decreasing at a greater rate than for an exponential probability density.

### Maximum Likelihood Estimation

The log likelihood of the probability density given by equation 1 for n data points for a simple linear model is from equation can be expressed as follows:

nln(p)+Σᵢ₌₁ⁿ−p|zᵢ|+ln[1+qH₃(|zᵢ|)]−ln(Q) (Eqn 2)

where for a simple linear model zᵢ=yᵢ−(α+βxᵢ) is based on dependent observations yᵢ and independent observations xᵢ.

The log likelihood of Equation 2 can be maximised to find the values of the unknown parameters. The form of the equation suggests an application of an EM algorithm where parameters p and q are estimated first using the algorithm of Buckland (1992b), then based on the log likelihood defined by the values of these parameters the values of other parameters associated with a chosen expectation model can be estimated. The equations for the maximum likelihood estimates, and standard errors, for the linear model, can be given as follows:

The log-likelihood (disregarding the constant term) is

L(α, β)=Σᵢ₌₁ⁿ[−p|zᵢ|+ln[1+q(|zᵢ|³−3|zᵢ|)]], (Eqn 3)

where zᵢ=yᵢ−(α+βxᵢ).

Since the log-likelihood function L(α, β) in equation (3) involves the modulus of the deviations zᵢ then L (α, β) is not differentiable with respect to the parameters α and β when any zᵢ=0. The nature of the maximisation means that this is very likely to occur for some zᵢ's and this usually occurs in practice. That is, the maximum will occur at the intersection of two ridges in the (α, β, L)-space at which zⱼ=zₖ=0. Accordingly, maximisation based on derivative free methods is necessary, for example, utilizing simplex optimisation or simulated annealing

Notwithstanding this difficulty, the first and second derivatives of the log-likelihood L(α, β) with respect to the two parameters α and β, needed for calculation of the standard errors, can be determined using generalised function theory as follows

$$\frac{\partial L}{\partial α} = p {\sum }_{i = 1}^{n} sgn ( {z}_{i} ) - {\sum }_{i = 1}^{n} \frac{( 3 q {\vert {z}_{i} \vert}^{2} - 3 q ) \cdot sgn ( {z}_{i} )}{1 + q {\vert {z}_{i} \vert}^{3} - 3 q \vert {z}_{i} \vert} , \\ \frac{\partial L}{\partial β} = p {\sum }_{i = 1}^{n} {x}_{i} sgn ( {z}_{i} ) - {\sum }_{i = 1}^{n} \frac{{x}_{i} ( 3 q {\vert {z}_{i} \vert}^{2} - 3 q ) \cdot sgn ( {z}_{i} )}{1 + q {\vert {z}_{i} \vert}^{3} - 3 q \vert {z}_{i} \vert} . \qquad ( Eqn 4 )$$

The standard errors are given by the variance-covariance matrix:

V=−H⁻¹,

where

$$H = [ \begin{matrix}\frac{{\partial }^{2} L}{\partial {α}^{2}} & \frac{{\partial }^{2} L}{\partial α \partial β} \\ \frac{{\partial }^{2} L}{\partial α \partial β} & \frac{{\partial }^{2} L}{\partial {β}^{2}}\end{matrix} ]$$

is the (generalised) Hessian matrix and

$$\frac{{\partial }^{2} L}{\partial {α}^{2}} = - 3 q {\sum }_{i = 1}^{n} \frac{( q {\vert {z}_{i} \vert}^{4} - 2 \vert {z}_{i} \vert + 3 q ) {( sgn ( {z}_{i} ) )}^{2}}{{( 1 + q {\vert {z}_{i} \vert}^{3} - 3 q \vert {z}_{i} \vert )}^{2}} - ( 2 p + 6 q ) {\sum }_{i = 1}^{n} δ ( {z}_{i} ) , \\ \frac{{\partial }^{2} L}{\partial α \partial β} = - 3 q {\sum }_{i = 1}^{n} \frac{{x}_{i} ( q {\vert {z}_{i} \vert}^{4} - 2 \vert {z}_{i} \vert + 3 q ) {( sgn ( {z}_{i} ) )}^{2}}{{( 1 + q {\vert {z}_{i} \vert}^{3} - 3 q \vert {z}_{i} \vert )}^{2}} - ( 2 p + 6 q ) {\sum }_{i = 1}^{n} {x}_{i} δ ( {z}_{i} ) , \\ \frac{{\partial }^{2} L}{\partial {β}^{2}} = - 3 q {\sum }_{i = 1}^{n} \frac{{x}_{i}^{2} ( q {\vert {z}_{i} \vert}^{4} - 2 \vert {z}_{i} \vert + 3 q ) {( sgn ( {z}_{i} ) )}^{2}}{{( 1 + q {\vert {z}_{i} \vert}^{3} - 3 q \vert {z}_{i} \vert )}^{2}} - ( 2 p + 6 q ) {\sum }_{i = 1}^{n} {x}_{i}^{2} δ ( {z}_{i} ) . \qquad ( Eqn 5 )$$

To derive these formulae generalized functions have been used:

$$sgn ( x ) = \{ \begin{matrix}1 , & x > 0 ; \\ 0 , & x = 0 ; \\ - 1 , & x < 0 ;\end{matrix}$$

δ(x) which is the delta function, that is, it is zero except at one point x=0 and satisfies ∫_{-∞}^{∞}δ(x)dx=1. These expressions and the modulus function are connected by:

$$\frac{d}{d x} \vert x \vert = sgn ( x ) , \\ \frac{d}{d x} sgn ( x ) = 2 δ ( x ) ,$$

where the differentiation is taken in a generalised sense. Since sgn(0)=0 and δ(zᵢ)=0 for zᵢ≠0 only one (but not both) of the terms on the RHS of equations (5) is non-zero for each zᵢ. Thus, the calculation of the information matrix V for the standard errors has to be made in the generalised sense if at least one of the zᵢ's is zero, as it generally appears to be in practice. Suppose that at the maximum likelihood estimate this happens at zₖ. Then

$$- ( 2 p + 6 q ) [ \begin{matrix}1 & {x}_{k} \\ {x}_{k} & {x}_{k}^{2}\end{matrix} ] δ ( {z}_{k} )$$

is a term in H when zₖ=0. In fact we expect two such terms when solving for two parameters, that is, H will be dominated by

$$- ( 2 p + 6 q ) [ \begin{matrix}1 & {x}_{j} \\ {x}_{j} & {x}_{j}^{2}\end{matrix} ] δ ( {z}_{j} ) - ( 2 p + 6 q ) [ \begin{matrix}1 & {x}_{k} \\ {x}_{k} & {x}_{k}^{2}\end{matrix} ] δ ( {z}_{k} ) ,$$

where k≠j.

The matrix

$$[ \begin{matrix}1 & {x}_{k} \\ {x}_{k} & {x}_{k}^{2}\end{matrix} ]$$

is singular and has eigenvalue zero corresponding to the eigenvector which is the transpose of the vector (−xₖ, 1) and has eigenvalue 1+xₖ² corresponding to the eigenvector which is the transpose of the vector (1, xₖ). That is, we have one zero eigenvalue and one positive eigenvalue. However, the sum

$$S = [ \begin{matrix}2 & {x}_{k} + {x}_{j} \\ {x}_{k} + {x}_{j} & {x}_{k}^{2} + {x}_{j}^{2}\end{matrix} ]$$

has zero determinant if and only if xⱼ=xₖ. In general, this will not happen, the determinant is strictly positive and S has two positive eigenvalues. As xⱼ approaches xₖ, one eigenvalue approaches zero. This enables calculation of the information matrix V.

The equation set 4 are set to zero to find the maximum likelihood estimates of α and β using simplex optimization or annealing. The standard errors are given by the inverse of the variance-covariance matrix.

It will often be the case that the deviation characteristics of the machine and also the sampling process are constant. Then parameters p and q can be regarded as fixed for these circumstances. Thus an early estimate of these parameters can be made by taking an initial number of repeat measurement samples. If the sample size is small, a Bayesian estimate of these parameters can be made using the previous estimates as the prior distribution. Because the parameter estimates of p and q are maximum likelihood, the joint probability density of these parameters is bivariate normal, so this becomes the prior distribution for the Bayesian estimates. A Bayesian estimation has the advantage of needing less samples since the information in a prior sample can be used.

If the parameters p and q in the probability density of Equation 1 can be treated as fixed, the log likelihood of Equation 2 can be maximised over the parameters in the expectation function alone, which allows for a simplification. Alternatively, an EM algorithm can be applied alternating the estimation of parameters p and q with the parameters of the expectation model z. The estimation equations and the matrix of standard errors for the linear model are given above.

### EXAMPLE 1

To illustrate the application of the theory developed above 40 samples were randomly drawn from the 1440 deviations measured by the repeated measurement of the same tissue as described earlier. A constant value of 0.55 was added to 20 samples and designated treatment H, while a constant value of 0.45 was added to the other 20 samples and designated treatment L. A uniform random variable sampled between 0 and 0.1 was added to each value to simulate the differences between individuals.

An analysis of variance was carried out on this simulated data set using both the maximum likelihood method derived above and the least squares technique of the prior art. The least squares estimates were not significantly different (P<0.22), with estimates of H=0.55±0.10 and L=0.46±0.10. However, the maximum likelihood estimates were highly significant (P<0.01) with estimates of H=0.55±0.04 and L=0.45±0.04.

Since this simulated example had the difference between H and L specifically manufactured it can be seen that using the Sequenom derived error data, the maximum likelihood method gives the correct answer for both estimation and inference. The least squares technique provides the wrong answer for inference. Also, note that the standard errors on the least squares estimates are inflated due to the distributional problems.

### EXAMPLE 2

### Application to Estimate the Effect of Parity on Methylation of the Promoter of Gene H19

The proportion of CpG methylation at 13 CpG sites in the promoter of the H19 gene measured on cord samples from the subjects described in the materials and methods section were analysed to determine the effect of parity by maximum likelihood using the methodology described above.

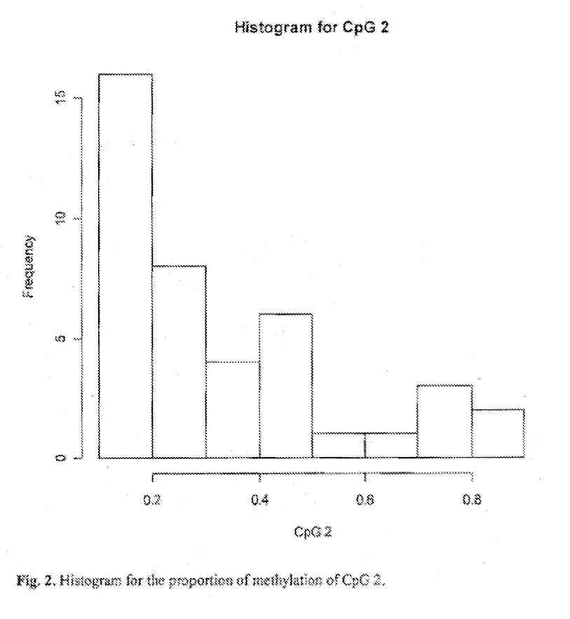

The frequency distributions of the methylation measurements at each CpG site exhibited a high degree of non-normality, all having skewed tails with a low frequency of high deviations. An example for CpG(2) is shown in FIG. 2. In these circumstances the least squares procedure of the ‘usual’ analysis of variance would be expected to perform poorly, and inference would be unreliable Taking logarithm transformations does not improve the situation, probably because the form of the tails of the methylation distributions falls faster than that of an exponential type.

The estimated effects from parity on the proportion of methylation for each of the measured CpG sites are shown in Table 1 below which shows maximum likelihood estimates and standard errors and least squares estimates of multiparous and primiparous effects on the CpG sites of the promoter of the H19 gene

TABLE 1

| | | | | Significance of |
|---|---|---|---|---|
| CpG | Muliparous | Primiparous | Significance | Least Squares |
| 1 | 0.12 ± 0.073 | 0.03 ±. 0.065 | ns (P < 0.1) | ns |
| 2 | 0.45 ± 0.067 | 0.18 ± 0.059 | 0.0006 | 0.05 |
| 3 | 0.41 ± 0.067 | 0.16 ± 0.059 | 0.0006 | 0.08 |
| 4 | 0.44 ± 0.067 | 0.12 ± 0.059 | 0.0001 | 0.06 |
| 5 | 0.43 ± 0.067 | 0.14 ± 0.059 | 0.0003 | 0.10 |
| 6 | 0.41 ± 0.067 | 0.13 ± 0.059 | 0.0000 | 0.06 |
| 7 | 0.45 ± 0.067 | 0.13 ± 0.059 | 0.0000 | 0.04 |
| 8 | 0.51 ± 0.067 | 0.23 ± 0.059 | 0.0000 | 0.09 |
| 9 | 0.48 ± 0.067 | 0.19 ± 0.059 | 0.0015 | 0.08 |
| 10 | 0.53 ± 0.067 | 0.25 ± 0.059 | 0.0009 | ns |
| 11 | 0.42 ± 0.067 | 0.16 ± 0.059 | 0.0031 | 0.07 |
| 12 | 0.53 ± 0.067 | 0.17 ± 0.059 | 0.0000 | ns |
| 13 | 0.57 ± 0.067 | 0.23 ± 0.059 | 0.0015 | ns |

All the CpG sites except CpG(1) (P<0.1) were highly significantly different for parity by the likelihood ratio test. Multiparous mothers have consistently higher proportions of methylation at all CpG sites than primiparous mothers. Even considering that multiple significance tests are being carried out the conclusion is that there is exceptionally strong evidence that parity is affecting the methylation status of the promoter of the H19 gene.

Table 2 illustrates the maximum likelihood estimates and standard errors and least squares estimates of SGA birthweight (adjusted for gestational age) effects on the CpG sites of the promoter of the H19 gene.

TABLE 2

| | | | Significance By | Significance of |
|---|---|---|---|---|
| CpG | SGA | AGA | Max Likelihood | Least Squares |
| 1 | 0.31 ± 0.098 | 0.35 ± 0.074 | ns | ns |
| 2 | 0.16 ± 0.094 | 0.19 ± 0.071 | ns | ns |
| 3 | 0.42 ± 0.094 | 0.39 ± 0.071 | ns | ns |
| 4 | 0.44 ± 0.110 | 0.58 ± 0.081 | P < 0.04 | ns |
| 5 | 0.25 ± 0.088 | 0.28 ± 0.064 | ns | ns |
| 6 | 0.35 ± 0.090 | 0.31 ± 0.068 | ns | ns |
| 7 | 0.36 ± 0.090 | 0.36 ± 0.068 | ns | ns |
| 8 | 0.34 ± 0.090 | 0.45 ± 0.068 | ns | ns |
| 9 | 0.44 ± 0.089 | 0.41 ± 0.069 | ns | ns |
| 10 | 0.37 ± 0.090 | 0.42 ± 0.068 | ns | ns |
| 11 | 0.41 ± 0.090 | 0.47 ± 0.068 | ns | ns |
| 12 | 0.37 ± 0.090 | 0.40 ± 0.068 | ns | ns |
| 13 | 0.38 ± 0.107 | 0.38 ± 0.078 | ns | ns |

In contrast the least squares analysis of variance inference tests (significance levels also shown for comparison in FIG. 2) were indeterminate except for CpG(2) and CpG(7). Consideration of the fact that multiple significance tests were being carried out renders the results even more problematic. The least squares estimates of the parity effect were also more variable. This is because both the inference tests and the least squares estimates are affected by the frequency of high deviation measurements. This result is similar to that found for the simulated data, where least squares gives incorrect inference.

However, the maximum likelihood method takes these effects into account during estimation through formal application of knowledge about the Sequenom methylation measurement deviations. The consistency of the proportion of methylation at all CpG sites in both parity groups is significant. This is probably because the maximum likelihood method is discounting the influence of high deviations because these deviations are occurring with the expected frequency described by the probability density. However, in least squares, a deviation of 0.15 is weighted 0.225, and has 100 times the influence as a deviation of 0.05 weighted 100 at 0.0025. In comparison the maximum likelihood procedure developed here would in principle weight these 2 observations the same if they occur with the frequency described by equation (2).

### Discussion

The skewed nature of the CpG methylation probability density and the bounds of this measurement between [0 1] mean that statistical analysis based on least squares (the usual case for an analysis of variance or regression) is unreliable. This is clearly demonstrated by the simulated data drawn from the Sequenom repeat measurements where the least squares technique fails to find the correct level of inference. This result is consistent with the analysis of the H19 gene data where least squares analysis gives indeterminate results, while maximum likelihood shows unequivocal significant differences in parity. Further problems arise if the expected value of the methylation is close to one of the boundaries inducing an asymmetry that least squares cannot effectively cope with.

Methylation measurement frequencies typically exhibit a long tail of low frequency high deviation values that respond poorly to log transformations aimed at inducing a normal distribution suitable for classical analysis. By deriving a suitable probability density based on a large number of repeat methylation measurements, maximum likelihood estimation methods can be developed to deal with these problems. This is because the method of maximum likelihood explicitly takes into account the nature of the probability density underlying the data. That is the method of maximum likelihood introduces knowledge about the methylation measurement process that is ignored by analysis based on least squares.

These results can be routinely applied to any CpG methylation data. It is recommended that an EM algorithm be applied whereby the parameters p and q in the probability density are estimated separately from the expectation model estimates, in this case α and β. This procedure can then be iterated until convergence of all estimates occurs.

It should be noted that any analysis is not confined to linear functions. The expectation function can also be nonlinear without loss of generality.

It will further be evident that the procedures of the preferred embodiments can be applied to the measurement of any biological process where non normal distribution of errors are present.

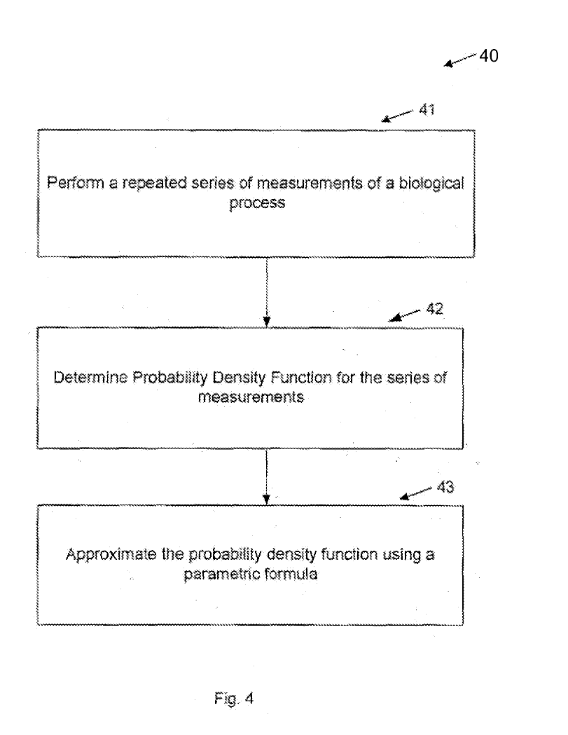

The preferred embodiment can therefore proceed by the steps as indicated 40 in FIG. 4. These include the step of performing a repeated series of measurements of a biological process 41. This is followed by determination of a probability density function for the measurements 41. Next an approximation to the probability density function is undertaken 43, using a parametric formula such as the one disclosed.

The foregoing describes preferred forms of the present invention. Modifications, obvious to those skilled in the art can be made thereto without departing from the scope of the invention.

1. A method of measuring a biological process, the method including the steps of:
(a) determining a probability density function for a series of repeated measurements of the biological process;
(b) approximating the probability density function utilising a parametric formula;
(c) determining a maximum likelihood estimator for the parametric formulation of the probability density function;
(d) utilising the maximum likelihood estimator for subsequent measurements of the biological process.

2. A method as claimed in claim 1 wherein said biological process comprises Cp methylation measurements.

3. A method as claimed in claim 1, the method including fitting a parametric exponential decay formula to the probability density function.

4. A method as claimed in claim 3 wherein further including fitting a parametric hermite polynomial to the residual after fitting the parametric exponential decay formula.

5. A method as claimed in claim 2 wherein the probability density function is of the form:
f(z)=Q⁻¹pe^{-p|z|}[1+qH₃(|z|)]
where |x| is the absolute value of the CpG methylation, p and q are parameters, H₃(z) is the 3^{rd} order Hermite polynomial, and Q is a normalisation constant.

6. A method as claimed in claim 5 wherein H₃(z) is of the form: z³−3z.

7. A method as claimed in claim 5 wherein the parameters p and q are obtained utilising a maximum likelihood process.

8. A method as claimed in claim 5 wherein said function is optimized utilising a log likelihood optimization process.

9. (canceled)
